(19) United States
(12) Patent Application Publication
(10) Pub. No.: US 2006/0151990 A1
(43) Pub. Date: Jul. 13, 2006

(54) Security device and system

(75) Inventor: Russell P Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Technology Limited

(21) Appl. No.: 10/527,756

(22) PCT Filed: Sep. 10, 2003
(86) PCT No.: PCT/GB03/03917

§ 371 Date: Oct. 3, 2005

(30) Foreign Application Priority Data
Sep. 10, 2002 (GB) 0220907.0

(51) Int. Cl. B42D 15/00

(52) U.S. Cl. 283/82

(57) ABSTRACT

Disclosed in a security device (700) comprising two or more magnetic elements (702). The magnetic elements (702) are responsive to an applied magnetic field to provide a characteristic response that is difficult to reproduce. The security device (700) finds application in detecting forgeries.

One aspect of the invention relates to a security device, for example to comprise an identification and/or authentication device for use in isolation or for use in association with, incorporated into or onto or attached to another article. The security device provides a characteristic response or signature for identification and/or authentication in a manner that limits or makes difficult the copying of the device, and consequently the copying or counterfeiting of any item used in association therewith. Another aspect of the invention relates to a data reader particularly suited to reading such a characteristic response/signature, to a method of producing/measuring such a characteristic response/signature in a security system including device and reader, and/or to an identification or authentication method using such a device and/or system.

A major loss of revenue to many businesses and a substantial source of criminal activity arises from illegal counterfeiting or copying of items. Examples include, but are not limited to:
Copying cards and like devices used for paperless financial transactions such as credit card and bank cards to allow unauthorised transactions and withdrawals from ATMs;
Forging and copying items used for identification, such as passports, visa documents, driving licenses, personal identity cards and the like;
Copying material carried on a data storage medium, such as CD and DVD disks;
Forging and copying official documents such as certificates;
Duplicating smart cards used for identity/access purposes, for example to control access to areas as part of a security system, to control access to services such as pay-TV, to control or log use of hardware such as computers or other office equipment in a multiple user environment;
Copying security or authenticity labels as part of counterfeit goods manufacture, to make unauthorised and/or inferior copies of high-value branded goods, high specification safety-critical goods and the like.

This is a particularly identified problem in relation to cards and like devices used for paperless financial transactions and for identification purposes, and this area has led development of security systems, which are nevertheless likely to be generally applicable to most or all areas where copying is a problem.

As paperless commercial and general security systems have become more sophisticated, increased automation coupled with an increased information storage capacity on the item have created great opportunities for financial and identity fraud by copying of such documents. The concentration of wealth and/or information accessible through credit and bank cards and identity documents has increased. There has developed a growing need for accurate verification and identification such items and/or effective copy prevention.

Card and documentary systems in particular have adopted measures that improve security by making counterfeiting difficult or inconvenient. This approach has concentrated in particular on incorporation of embedded devices on or in the card or other document which are difficult to copy effectively. Examples include holographic images, diffraction gratings, specialist substances (inks, materials etc), embossed structures, structures within the material of the card, etc.

Ultimately though, these markings can be copied by the sophisticated counterfeiter, and will be if the rewards are sufficient. There exists a general desire for a security marking that cannot practically be counterfeited.

An effective strategy against unauthorised copying of items exists if a random signature or characteristic response can be associated with the item or with a device that is attached to the item. The random signature/characteristic response could come from some uncontrollable manufacturing process that can never be duplicated precisely. Thus, there always exists some small difference between the original item and its copy, if this difference can be detected and compared with a previously measured response (e.g. a baseline response in which the response of individual magnetic elements are recorded separately, or the average response of a collection of such magnetic elements are recorded) taken from the original item, forgery can be identified.

There are 4 primary preferred requirements of a practical random signature:
That it be possible to measure the signature easily and without excessive cost;
That it be possible to represent the baseline signature easily, preferably by a small list of digital numbers.
That there be a large degree of randomness inherent in the manufacture of the signature, such that every signature is slightly different
That it not be possible to control the manufacture of the signature so that its randomness could be stripped out or suppressed and an identical copy of an existing signature made.

Difficulties in achieving all of these requirements have to date limited the practical applicability of the concept on a wide scale in everyday systems.

Viewed from a first perspective the invention provides a security device for an item which is inherently difficult to copy and thus limits counterfeiting.

Viewed from another perspective the invention provides a security device for an item based upon a random signature which is readily manufactured and measurable on a scale and at a cost appropriate for everyday use in authentication/counterfeit prevention of high value items.

Viewed from a further perspective the invention provides a data reader particularly suited to reading the signature of such a device.

Various aspects of the invention are described herein and set out in the appended claims.

Thus, according to the invention in a first aspect there is provided a security device comprising at least one and preferably a plurality and more preferably a large plurality of magnetic elements arrayed on a suitable substrate and having a machine readable magnetic signature response, provided in combination with a predetermined baseline magnetic signature response reading.

In various embodiments, the magnetic elements may comprise thin layer magnetic material, such as thin magnetic wires or strips, or dots. The magnetic material may be in the micro, macro or even nanoscale, and may include microwires or microdots, or even nanowires or nanodots, laid down in suitable form on a suitable substrate to give a machine readable magnetic marking, with a measurable baseline signature signal highly dependent upon the precise inherent structure. The predetermined recorded baseline signature response gives a comparative figure, an “expected” response which can be used in connection with a measured response to authenticate the device.

As used herein, “device” at its broadest comprises the magnetic elements) as hereinbefore described to be laid down on a suitable substrate, such as, for example, the surface of an item to which a security device is to be applied. Examples of the application of such a device include without limitation such a device constituting or comprising a part of an object adapted for use in its own right as an identification, authentication, key or any other application; a device constituting or comprising part of such an object provided for use with a second object, in particular for example as an attachment thereto, for authentication, identification or other labelling, related security or other purposes; a device portion incorporated into or onto a second item for such identification, authentication or related security or other purposes. In particular, the device is provided to authenticate and impede/prevent unauthorised counterfeiting by copying or cloning of an article of which it forms a part, or with which it is associated.

Examples of suitable collections of magnetic elements are described in R. P. Cowburn, Journal of Physics D, 33, R1 (2000). The present invention may rely upon their singular effectiveness in creating a random signature for anti-forgery.

The magnetic elements are such that when a time-varying magnetic field is applied to the elements, their magnetic response is a non-linear and hysteretic function of that applied field. This non-linearity may be characterised by discrete jumps in the magnetisation at certain applied field values. The elements are such that the small differences in fabrication which must naturally exist from one element to another will cause the magnetic response to vary slightly from element to element. Furthermore, for various embodiments, the elements are such that a given element responds in as similar a way as possible to each cycle of the time-varying applied magnetic field.

In order to determine the baseline signature response of a collection of magnetic elements, a time-varying magnetic field is applied to the elements, and the magnetic response of the elements is recorded. The response can be measured using the device described herein, or by some other means.

The baseline response may be condensed by identifying specific features, such as sudden jumps, or the mean and standard deviation of the switching fields. Alternatively, the baseline response may be converted from a time-domain sequence of magnetisation measurements to a frequency-domain list of measurements. Alternatively, the baseline response may be unprocessed

Measuring the predetermined baseline response is analogous to a calibration procedure. It is anticipated that the predetermined baseline response will only be measured once, at the time of manufacture and that the device will then be supplied to the user with the predetermined baseline response stored in a manner accessible to the user, for example remotely from the device, or in association with the device in a form inaccessible without authorisation. In particular, it is desirable that the predetermined baseline response is securely encrypted, especially if held on or with the device. Preferably the predetermined baseline signature response is encrypted using an asymmetric encryption algorithm with the private key used for enciphering being kept secret and the public key used for deciphering being made available to any reader of the device such that the expected predetermined baseline signature response can be decrypted and comparison can be made with a measured response.

In order to test the authenticity of an item protected by a random signature, it is necessary in various embodiments to apply a time-varying magnetic field to the magnetic elements and to record the measured magnetic signature response of the elements to that applied field. The same procedure is used first to determine the predetermined, expected baseline response which is then stored as above, and then by use of a suitable reader to obtain subsequently measured baseline responses which can be compared to the predetermined, expected baseline response to authenticate the device.

Authentication relies on the inherently random nature of the device. Artificially fabricated magnetic elements make a very good practical random signature because the magnetic switching field of each element depends critically upon the physical structure of the ends of the elements. Structural variations of only a few nanometres in size can cause significant changes to the switching field (K. J. Kirk, J. N. Chapman, and C. D. Wilkinson, J. Appl. Phys. 85, 5237 (1999)). Therefore, in order to replicate the random signature, it is necessary to replicate the precise shape of the elements to near-atomic precision. This is unfeasible using current technology and is likely to remain so for many decades. While near-atomic level manipulation is required to copy the device described in this invention, a macroscopic measurement is sufficient to check authenticity, because when the structure undergoes magnetic switching, the entire structure switches together, making the magnetic response very easy to measure. Thus, the random signature according to this invention requires low-cost, simple processes to interrogate it, but unfeasibly difficult engineering to copy it. This is ideal for a practical random signature.

If the magnetic response of a collection of elements is recorded together as an ensemble measurement, it must be appreciated that the statistical fluctuations upon which this invention is based will be attenuated. The attenuation factor will be 1/\sqrt{N}, where N is the number of nominally identical elements in the ensemble. Thus, if a collection of individual elements has a switching field with a standard deviation of 10 Oe, then a collection of ensembles of 100 elements will only have a standard deviation of 1 Oe. The measurement of the magnetic response must therefore be made more carefully. On the other hand, the total volume of magnetic material has increased by a factor N, which makes the measurement easier to make.

In various embodiments, authentication relies upon a match between the measured baseline response of the device, and a predetermined baseline response stored securely, in particular in encrypted form. A forger attempting to forge a device incorporating a prerecorded baseline response in an encrypted form will be extremely unlikely to produce a perfect forgery having a measurable magnetic signature response matching an encrypted prerecorded original. In the genuine device, the predetermined baseline response is recorded in an encryption known only to the manufacturing company or those authorised thereby. If the prospective forger merely tempts to copy both the signature device and the encrypt derived therefrom the forgery will fail, because even if the encrypt is copied exactly the magnetic signature response of the copied device will differ from the original. Thus, on the forgery, the measured and predetermined and recorded signature responses will not match. If the forger creates a copy of the signature device, he could instead measure the baseline response of the forged device readily. However, he could not create a suitable valid encrypt corresponding to the forged baseline response because he does not know the encryption Thus, both possible copying strategies fail.

Thus, in accordance with various aspects of the invention, a practical method of generating and reading a random signature using artificially structured magnetic materials is described which is for practical purposes nearly impossible to copy, and which thus offers a security device which can authenticate originals and prevent counterfeiting by copying of such originals.

The magnetic elements of various embodiments comprise thin layers of magnetic material, preferably less than 1 μm thick, and more preferably less Man 100 nm thick. They may be 10 nm thick or less, but by preference will be generally around 40 nm thick.

The elements may all be nominally identical in shape and of regularly distributed arrangement, or differences between them and/or irregular patterns of arrangement may have been intentionally introduced. It should be emphasised that the random nature of the magnetic response is an inherent consequence of material fabrication, not dependent upon the shape, configuration and distribution pattern of the elements.

The elements may be generally rectangular in shape, in particular elongate rectangular for example comprising an army of generally parallel magnetic elongate rectangular elements, or may comprise areas of magnetic material, for example being square or circular, or some other regular geometric shape, which may for example be formed into a two dimensional array.

As used herein reference made to magnetic wires, microwires or nanowires should be construed as being to such elements of elongated form, and in particular elongate rectangular elements and/or elongate elements in a generally parallel array, but not restricted to the parallel rectangular examples given herein for illustration purposes. As used herein reference made to magnetic dots, microdots or nanodots should be construed as being to such elements comprising areas of magnetic material of less elongate, more squat form, and in particular of regular geometric shape, and/or formed into a two dimensional array, but not restricted to the circular geometry of the examples given herein for illustration purposes.

The elements may be discrete, with no magnetic material connecting them, or they may be partially connected by magnetic material into a number of networks, or they may be entirely connected by magnetic material into a single network.

The elements may be made from a magnetic material, which will by preference be magnetically soft, for example based on nickel, iron, cobalt and alloys thereof with each other or silicon, such as nickel iron alloy, cobalt iron alloy, iron silicon alloy or cobalt silicon alloy.

The elements may be coated with a protective overlayer to prevent oxidation or mechanical damage, said protective over layer comprising a thin layer of non-magnetic material having suitable mechanical and/or environmentally-resistant properties and/or surface treatments and/or coatings, for example comprising a layer of ceramic, glass or plastics material. Such overlayers are conveniently transparent. Particular examples of protective overlayers include titanium dioxide, transparent epoxy resin, plastic or glass, transparent modified silicone resin conformal coating and transparent acrylic conformal coating.

The elements are laid down upon a suitable substrate. An underlayer may exist between the elements and the substrate. The device may be incorporated directly into or upon the item which is to be protected, in which case the substrate may be the item which is to be protected against forgery itself or some suitable substrate material laid down thereupon or incorporated therein for the purpose. Alternatively, the device may be incorporated into a separate unit such as a tag, label, certification etc, attachable to or otherwise useable in conjunction with an item to be protected, the attachable unit comprising or incorporating some suitable substrate material. Suitable substrate materials include silicon, glass, plastic or some other material with a smooth surface.

In the case of the magnetic elements being formed on an attachable unit, the attachable unit may be attached directly to the item to be protected, or may form part of a certificate or other documentation associated with the item to be protected. Means may be provided in association with an attachable unit to effect attachment between the unit comprising an identification device in accordance with the invention and the item to be protected. Such means may provide for releasable, removable engagement of the attachable unit to the protected item, or for permanent engagement thereupon. In the former case, attachment means may further comprise locking means to ensure that only authorised persons can remove the unit. In either case, the attachment means may further comprise anti-tamper protection and/or mechanisms to indicate tampering by unauthorised persons.

Suitable uses for such attachable unit include, without limitation, labels for items of value, of security importance, or of otherwise critical importance, for example to enable identification of the article, authentication of the article as genuine, verification of the provenance of the article and the like and/or to label the article in a secure and controlled manner, for example with information about the article, pricing information, stock control information etc.

In the case of magnetic elements being formed directly upon an item to be protected, similar usages might also be envisaged. Such direct incorporation of the device onto the item to be protected however will be singularly effective in preventing unauthorised reproduction, given the random and hence inherently non-controllably reproducible nature of the signature device, and will therefore be particularly useful in association with items which might be susceptible to the production of counterfeit copies, since the device will provide for ready authentication of an item as original.

The elements may be formed by optical lithography, for example, using the method described herein, although embossing or some other form of contact printing may be used.

The plurality of elements making up the device may be of generally the same size and shape, or may have a size and/or shape differing continuously or discontinuously across the device. Preferably, a number of different element sizes will be present in one ensemble.

In one embodiment, several discrete groups of differently sized and/or shaped elements, the elements being generally similarly sized or shaped within each group, are provided so that several different switching fields can be identified. For example, an ensemble of rectangular elements in parallel array may comprise several discrete groups of different widths.

A suitable example comprises 100 rectangular elements, each 1 mm long; 10 will be 5.0 μm in width, 20 will be 2.5 μm in width, 30 will be 1.7 μm in width, 40 will be 12 μm in width The magnetic response of such an ensemble will then show four distinct groups of switching fields, each of which will exhibit a statistical variation from one tag to the next which can be used to form a random signature.

A second example comprises 450 rectangular elements, each 1 mm long, 150 will be 1.0 μm in width, 120 will be 125 μm in width, 90 will be 1.67 μm in width, 60 will be 2.5 μm in width and 30 will be 5 μm in width. The magnetic response of such an ensemble will then show five distinct groups of switching fields.

In the examples, the number of elements in each group is such that each group should cover generally the same area The strength of the detected signal from the reader usually depends upon the total area of coverage, so each of the four or five groups of switching fields will register the same strength at the reader. This is a preferred feature for many applications, but it can be envisaged that for other applications several discrete groups of differently sized and/or shaped elements may be provided wherein different groups occupy different areas of the device.

In an alternative embodiment, differently sized and/or shaped elements are provided in a continuously varying array, so that variations in size and/or shape between an element and its neighbours are minimised to avoid large discontinuities. For example the area of an element should vary from its neighbours by no more than 5% and in particular by about 1%. As a result, a smoothly varying collection of switching fields is produced. The variation could be tuned in accordance with a suitable functional form which may be linear or non-linear.

For example, in an analogous device to that described above with rectangular elements in parallel array the width of the elements varies as a smooth function across the array. An ensemble might start with a 2.5 μm wide wire; the next would be 2.53 μm, the next 2.56 μm etc, until 56 wires later the width has risen to 5 μm. The total wire width is 200 μm in this example. An alternative ensemble might start with a 1 μm wide wire; the next would be 1.01 μm, the next 1.02 μm etc, until 450 wires later the width has risen to 5 μm. Different functional forms, e.g. linear, quadratic etc could be used to determine the progression of widths across the ensemble. Unlike the previous example, this would not give distinct groups of switching fields, but rather a smooth collection of switching fields.

In one embodiment, the device, in addition to the signature array comprising a large plurality of signature elements, comprises a single relatively large area magnetic element for use as a reference element, for example a relatively wide magnetic nanowire. In the foregoing examples such a single wide wire could be 1 mm long and 150 μm wide. For a wire at such a large width, the magnetic property is almost identical to the bulk material, which is usually quite well defined. Thus, in addition to five blocks which have erratic switching fields there is provided one well defined switching field, which can be used to calibrate the reader. This calibration could include making environmentally-based adjustments, such as subtracting the influence of the Earth's magnetic field, for example, or compensating for changes in temperature.

It is necessary that a predetermined base line magnetic signature response is provided in combination with a security device in accordance with various of the embodiments of the invention. It will however be understood that it is not necessary that such a predetermined base line magnetic signature response is provided in physical association with the security device, but merely that it is available to the authorised user of the device for comparison purposes to give an “expected” response to be compared with an actual response when the device is read by suitable means, such as the magnetic signature reading means described herein.

Various embodiments may be provided. In a first, the pre-recorded baseline may be provided in physical association with the device or protected item. In a second, the pre-recorded baseline may be stored by a device reader. In a third the pre-recorded baseline may be remotely stored from both device and device reader in a manner accessible to an authorised person such that the necessary comparison between expected (i.e. pre-recorded) and actual (measured) baseline readings can be made for authentication purposes.

In the first embodiment mentioned above, the pre-recorded baseline response is provided in close physical association with the device or protected item. In one alternative, the prerecorded baseline is stored in physical proximity to the device in machine-readable form. For example, the pre-recorded baseline is stored as a part of the device; or is stored adjacent to or under the device on a common substrate; or is stored in the vicinity of the device as part of a unit incorporating the security device of the invention, optionally with other security or information features, such as a smart card, identification document, key card, key fob or the like, or a label for an article to be protected; or is stored on or with an article to be protected which article to be protected has also been provided with a device in accordance with the invention; or is stored as part of a certificate or other documentation associated with an item to be protected which certificate or other documentation may also incorporate such a device in accordance with various embodiments of the invention.

In this embodiment, the prerecorded baseline should be stored in readable but encrypted form. For example, the condensed or unprocessed baseline response is digitally signed using an asymmetric encryption algorithm such as RSA. The private key, which is used for enciphering, is known only to the manufacturing company; the public key, which is used for deciphering, is held on every reader terminal which might be used to read the device.

The digitally signed and encrypted baseline response is stored on the item, preferably with the magnetic elements for example in that it is printed underneath or alongside the elements, or alternatively by recording it onto a magnetic data strip, or by recording it onto an optical bar code or by recording it onto a smart card chip, or by some other means. Other information, such as, but not limited to, the owner's name or a unique identity code or a checksum may also be encrypted into the same data stream and digital signature to prevent the magnetic elements from being transferred to another item or important information on a document or certificate from being modified.

In the second embodiment referred to above, the prerecorded/premeasured base line response is stored on, by or in close association with a device reader. Such an embodiment lends itself in particular to “lock and key” type systems where the device acts as a key and is used in association with a reader acting as a lock to limit access to particular areas, operation of particular items, or use of particular services to the specified key holder(s).

In this embodiment, it is not necessary for prerecorded baseline signature data to be stored upon or in close association with the device itself or a protected item. Optionally however, the data may still be stored in an encrypted form for security, for example in the manner above described, or may be otherwise security protected.

In the third embodiment referred to above, the prerecorded/premeasured baseline signature data is stored remotely from both the device and protected item and the device reader. Such a mode of operation lends itself in particular to, but is not limited to, systems where a network comprising a large number of readers each expecting to interrogate a large number of devices is envisaged, for example as might be the case with credit cards and the like with multiple points of sale, security and identification systems with multiple points of access etc.

In accordance with this embodiment prerecorded signature data about the device, and in particular about a plurality of different devices, is preferably stored at a central data store, for example connected to a plurality of readers on a distributed network In such a network two alternative modes of operation can be envisaged. In the first, a reader is adapted to read a device, interrogate a central data store for the prerecorded signature data, and make the comparison. In a second, the device reader is adapted to read the device and pass the actual signature data to such a central data store for verification purposes. The essential principles remain the same.

In a further aspect of the invention there is provided a security system including at least one device as hereinbefore described and at least one device reader, said device reader comprising means to read the magnetic response of the device. In particular, the device reader comprises or is provided in association with a magnetic field generator to apply a time-varying magnetic field to the elements, and has a magnetic response recorder to record the response of the magnetic element to that applied magnetic field. An embodiment of a device reader is described herein.

For different applications, suitable systems may comprise a plurality of such readers and/or a plurality of such devices. A system comprising a plurality of such readers may be arranged such that each reader functions independently in isolation, or such that some or all of the readers are linked on a distributed network.

Readers provided for a system operated in accordance with the first mode of operation outlined above preferably further comprise means to read the pre-recorded predetermined baseline signature response, in particular the pre-recorded and encrypted signature response, stored on, with or in association with a device or protected article; and preferably further comprise comparator means to compare the prerecorded and measured baseline signature responses. Readers adapted for a system for use in accordance with the second mode of operation described above preferably further comprise storage means for storing the predetermined baseline signature response(s) of the device(s) intended for use therewith, and preferably further comprise comparator means to make a comparison between stored and measured baseline responses. Readers intended for use in accordance with the third mode of operation described above preferably comprise means to receive data concerning a remotely stored predetermined baseline signature response, for example via direct entry of data by a user, or via interrogation of a remote database on a distributed network, together with comparator means to compare the predetermined response to the measured response; or in one alternative, means to transmit the measured response to a remote comparator, which comparator incorporates or is in data communication with a store of predetermined responses.

In all cases, the device reader preferably makes a comparison between the measured and predetermined baseline magnetic signature responses, for example against a predetermined tolerance limit, and actuates a response mechanism depending upon whether signatures are identical, for example within those tolerance limits.

The response mechanism may comprise a simple display means, of any suitable form, including visual, audio, alphanumeric indicators and the like, of whether the device is authenticated. Additionally or alternatively, other responses may be provided for. For example, authentication might serve to release a real or virtual lock, permitting access to a restricted area, operation of an item of restricted equipment, access to a particular service or the like.

According to a further aspect of the invention, a simple device is described which can measure the magnetic response of a small area of thin-film magnetic material. The device is well suited, but not limited, to measuring the magnetic random signature of a device such as described above. The small area will by preference be of size 0.2 mm×0.2 mm or greater, the magnetic material will be in the thickness range 1 nm to 500 mm, and by preference will be in the range 1 nm to 50 nm. The magnetic material may be a continuous film or may be a collection of magnetic elements. The magnetic material may have a transparent protective overlayer. In various embodiments the magnetic material remains optically reflective.

In various embodiments according to this aspect of the invention a device for measurement of the magnetic response of such an area of magnetic material as a time-varying magnetic field is applied to the magnetic material comprises an illumination source, and in particular an infra-red illumination source; a collimator to focus the illumination onto the surface of the magnetic material; and a collector to collect reflected illumination, and to monitor the varying response of this reflection over time as the time-varying magnetic field is applied. Optionally, the device incorporates or is provided with a magnetic field generator to generate such a field.

In various embodiments, the transverse magneto-optical Kerr effect is used to measure the magnetic response of the area of magnetic material as a time-varying magnetic field is applied to the magnetic material. This effect is well known in the literature. The response measuring device may incorporate additional means to apply such a time varying magnetic field to the area of magnetic material under investigation, or a separate device may be used to apply the same.

In various embodiments the device operates without polarised light Conventionally, the transverse Kerr effect requires the incoming light to be plane polarised. This is usually achieved by inserting a sheet of Polaroid or some other polarising optical element in the in-coming beam path It has been surprisingly found that in application to this invention, the polariser can be removed to reduce manufacturing cost and to reduce the size of the device. In the preferred embodiment of the present device a polariser is absent. This is suitable for many applications. Nevertheless it will be understood that a polariser may be included, for example in the in-coming beam path in conventional manner, where this is desirable or necessary.

Preferably, the collimator comprises a pinhole. At the scale of device operation this is found to effectively focus the light without the need to use a lens. This again reduces manufacturing cost and reduces the size of the device. Conveniently, the pinhole has diameter in the size range 0.2 mm-5 mm.

The light is then reflected off the surface of the magnetic thin film Preferably, a second pin-hole, with diameter in the size range 0.2 mm-5 mm, is provided to focus the reflected light It is preferred that the second pin-hole should have the same diameter as the first pin-hole. Light is passed to a collector comprising a light sensitive device, which is by preference a phototransistor or photodiode sensitive to the radiation produced by the light source.

In various embodiments, the light source comprises a light emitting diode. This is in contrast to prior art large scale devices for measuring the magneto-optical Kerr effect where a laser or a discharge lamp or an incandescent lamp is used. The present device is smaller, cheaper and removes the hazards associated with a product containing a laser.

An infra-red light emitting diode (LED) is preferred over a visible spectrum LED for two reasons: high optical intensities are achievable in the infra-red due to the higher currents that infra-red LEDs can sustain; the optical receiver can be rendered insensitive to visible light, thus reducing interference from ambient light.

In various embodiments, the light source comprises a laser diode. Laser diodes are relatively inexpensive and can provide high intensity light.

In a further aspect of the invention, a method of manufacture of a security device comprises forming at least one, and preferably a large plurality of magnetic elements as above described; obtaining a baseline signature magnetic response for the elements; storing the baseline response as a predetermined baseline response in a form accessible to a user of the device, optionally by encrypting and storing in physical association with the device in any readable form.

In various embodiments the elements will be formed by optical lithography.

In various implementations according to this aspect of the invention, a cost saving can be made in the lithography process in the case of the magnetic elements comprising an array of generally rectangular structures. The photoresist is applied to the substrate in the usual fashion and patterned by an optical exposure followed by development. The magnetic material is then deposited onto the patterned photoresist Usually, the photoresist would then be dissolved in a solvent (lift-off process). However, the photoresist can be left in place, because the magnetic material deposited on top of it forms a second set of rectangular magnetic elements. For example, suppose that the resist had been patterned into rectangular structures of width 0.5 μm with a centre-to-centre spacing of 1.5 μm. If the photoresist is left in place, then the structures comprise a set of 0.5 μm wires attached to the substrate, and an equal number (minus 1) of 1 μm wires attached to the top of the substrate.

The invention in a further aspect comprises a method of marking an item for security, identification or authentication purposes by use of the foregoing device and/or system and/or method and in particular by associating a device as hereinbefore described therewith.

The invention in a further aspect comprises a method of identifying or authenticating an item by use of the foregoing device and/or system and/or method and in particular by associating a device as hereinbefore described therewith, applying a time-varying magnetic field to the elements thereof to obtain a measured baseline magnetic signature response, for example using the reader hereinbefore described, and comparing the measured response to a predetermined recorded baseline magnetic signature response.

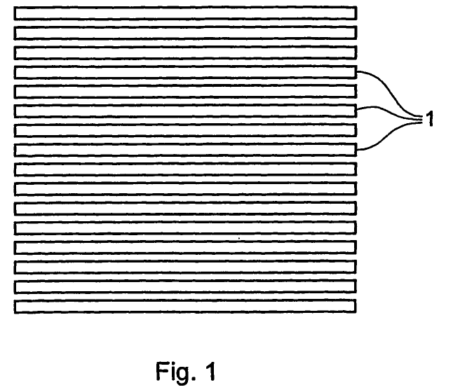

The invention will now be described by way of example only with reference to FIGS. 1 to 16 of the accompanying drawings in which:

FIG. 1 is an illustration of a first collection of magnetic elements used for a random magnetic signature in accordance with the invention;

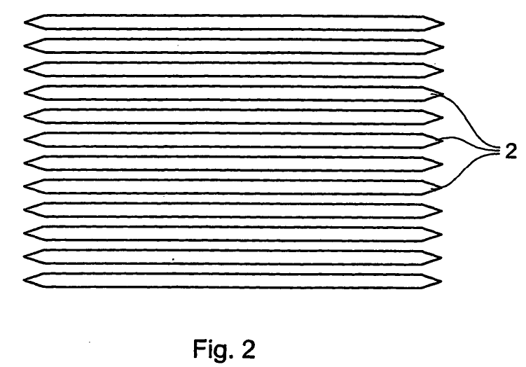

FIG. 2 is an illustration of a second collection of magnetic elements for such use;

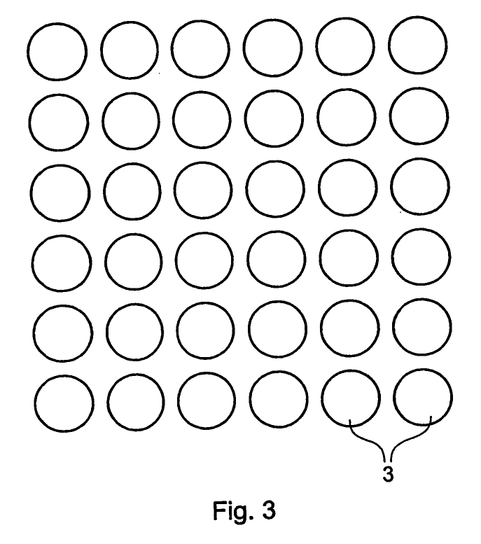

FIG. 3 is an illustration of a third collection of magnetic elements for such use;

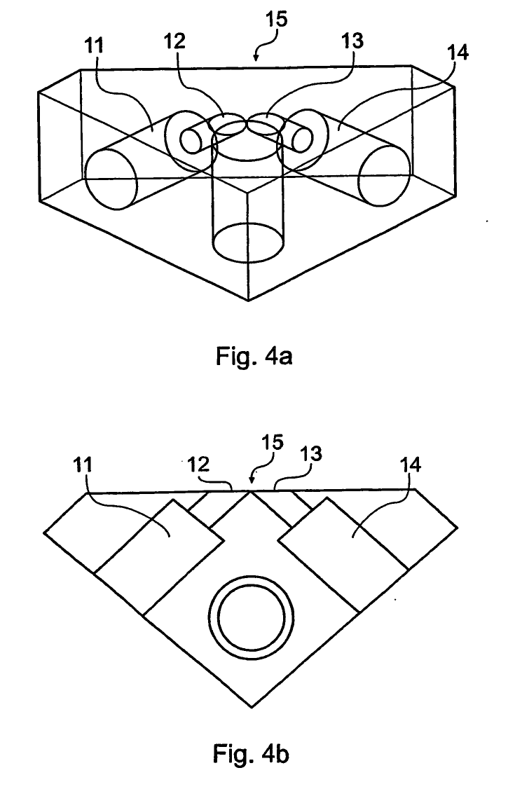

FIG. 4 is an illustration of a device for measuring the magnetic response of a small area of thin magnetic film, such as the signatures in FIGS. 1 to 3;

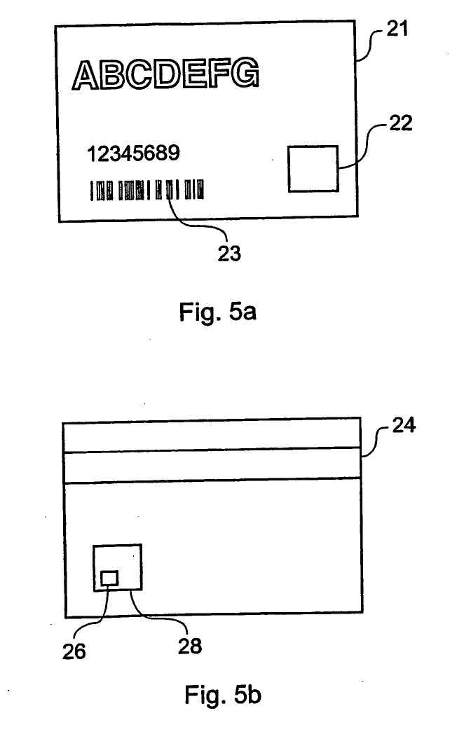

FIG. 5 is an illustration of an embodiment of the invention in a smart card;

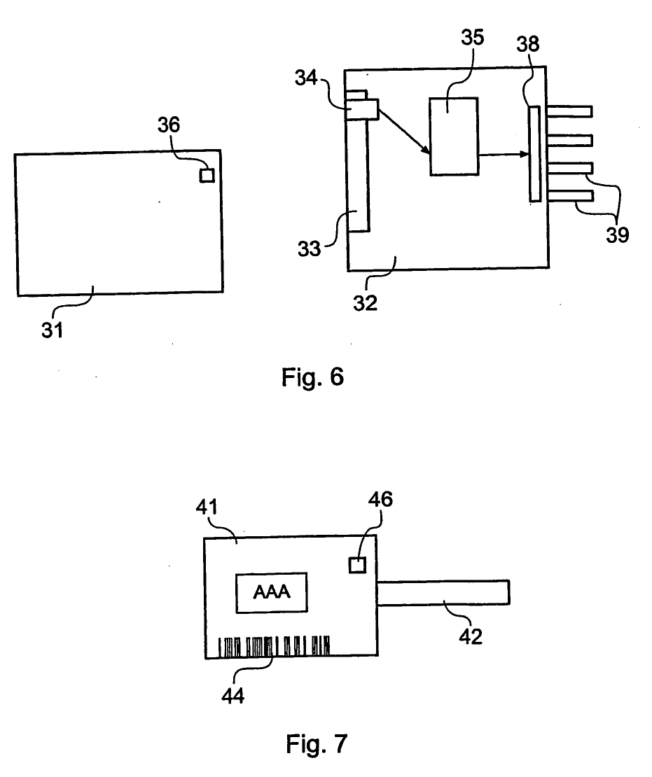

FIG. 6 is an illustration of an embodiment of the invention in an electronic key;

FIG. 7 is an illustration of an embodiment of the invention in an identity tag for attachment to an item to be protected;

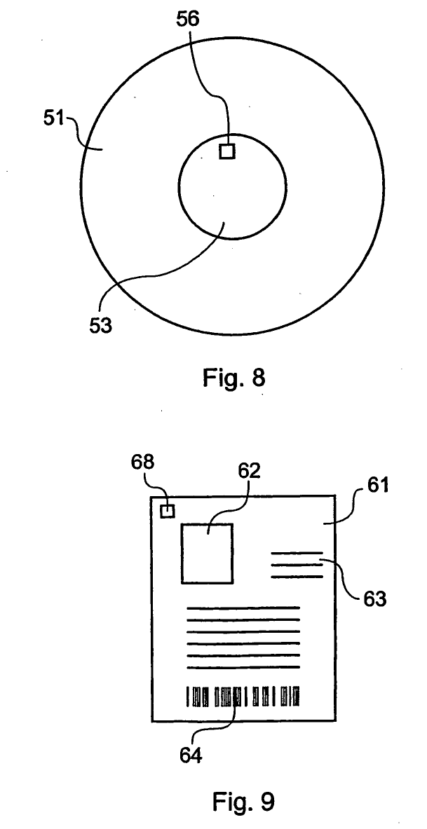

FIG. 8 is an illustration of an embodiment of the invention incorporated into a CD for authentication purposes;

FIG. 9 is an illustration of an embodiment of the invention incorporated onto a certificate for authentication purposes;

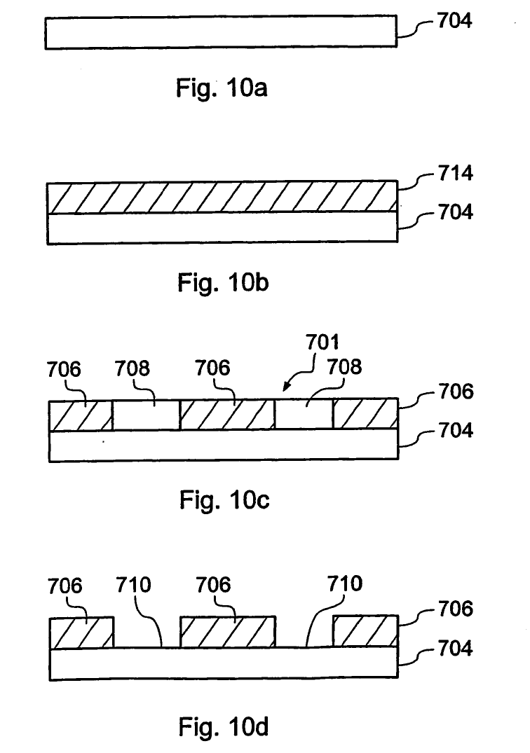

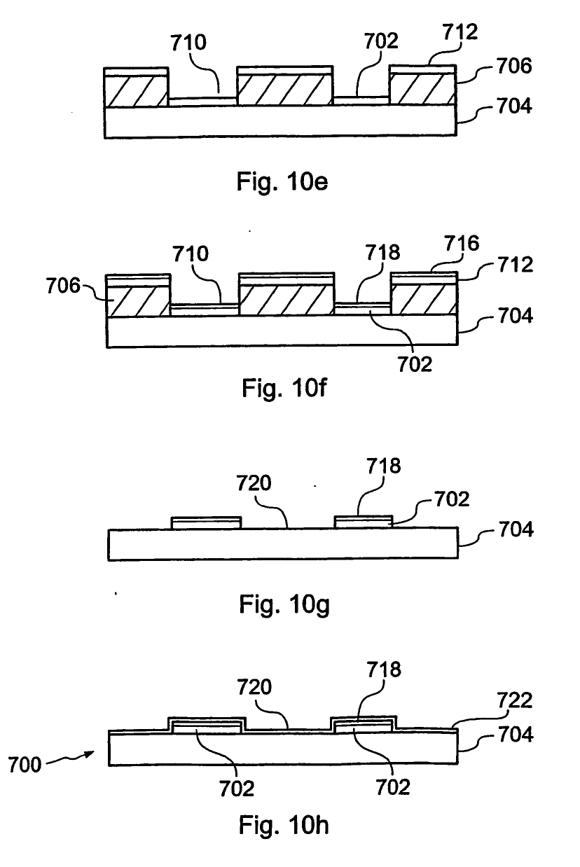

FIGS. 10a to 10h illustrate a manufacturing technique for producing various embodiments of security devices according to the present invention;

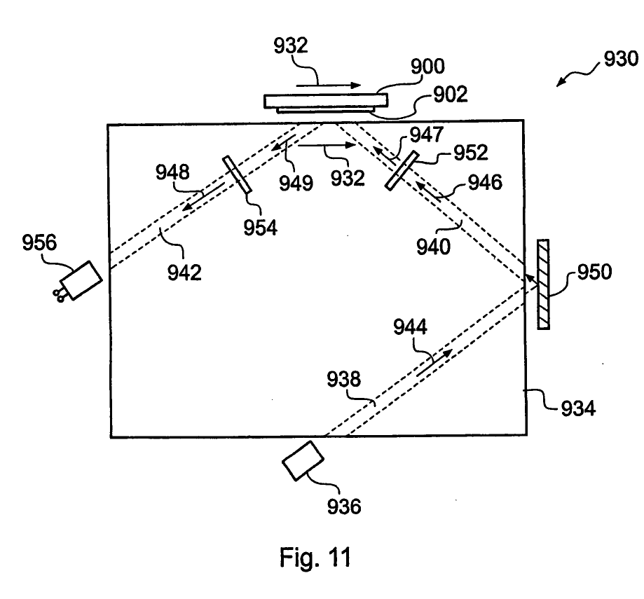

FIG. 11 shows a reading arrangement according to the present invention;

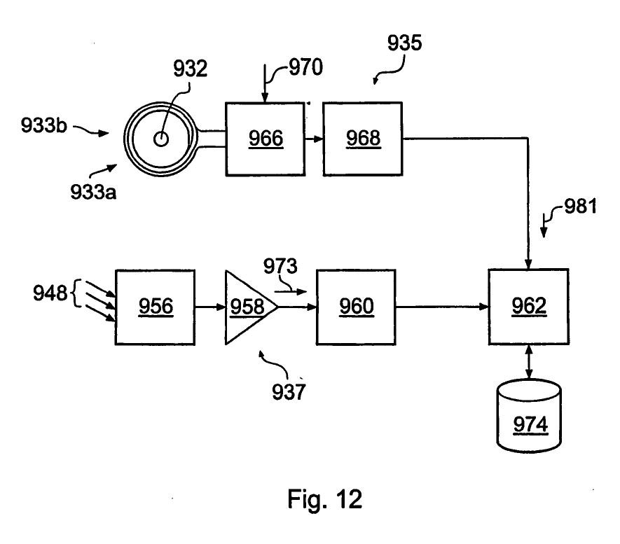

FIG. 12 shows a component of reading arrangement according to the present invention;

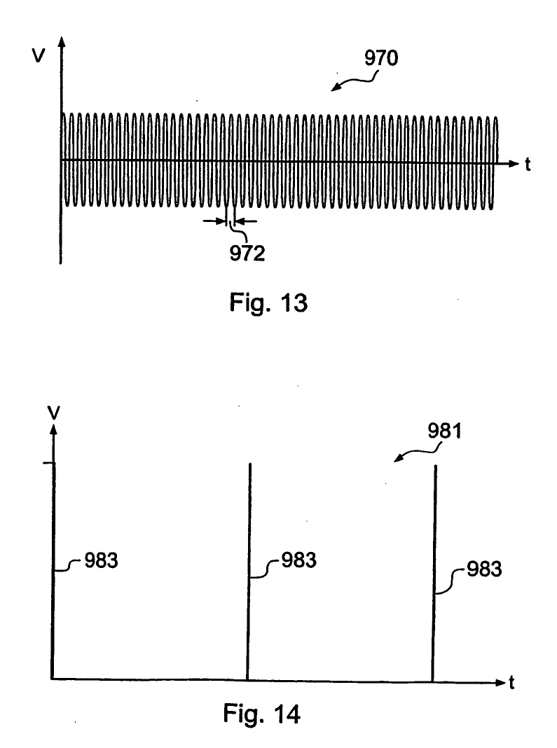

FIG. 13 shows a coil driving signal;

FIG. 14 shows a synchronisation signal;

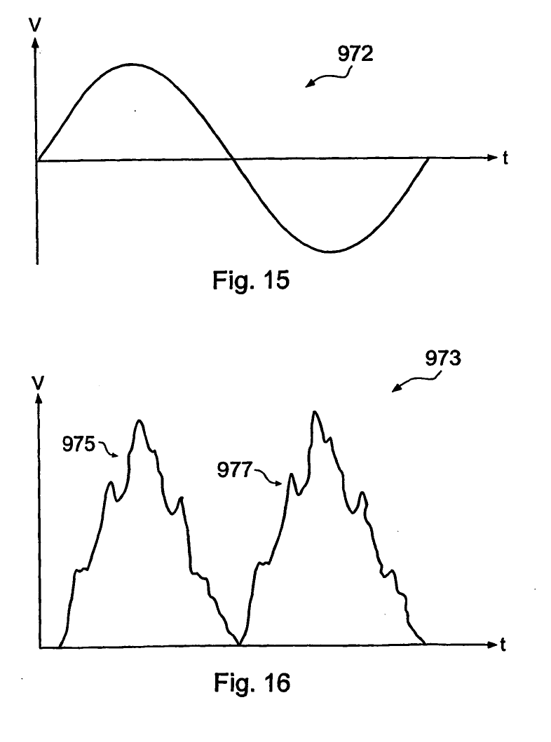

FIG. 15 shows a coil driving signal; and

FIG. 16 shows a unipolar detector signal.

Referring first to FIGS. 1 to 3, illustrations of three example structures of magnetic elements are provided in plan view.

In the first, a collection of regular rectangular magnetic elements (1) is shown schematically and not to scale. The material of the elements is Ni₈₀Fe₂₀. The material is laid down to a thickness of 40 nm. The overall area of the signature portion is 1 mm by 1 mm. The illustration is schematic only and not to scale. In particular it should be appreciated that each 1 mm by 1 mm area will comprise a very large plurality of elements of micron-scale width.

Moreover, any representation that the elements are of equal widths is schematic only. An array of 1 μm wide wires might be suitable for some applications. However, as has been noted above, any array of discrete groups of different wire width giving several discrete switching fields (for example as above described), or a continuously varying array with width varying in linear or other functional manner (for example as above described), will often be preferred.

FIG. 2 shows a generally similar structure having generally similar dimensions. The caveats above about the schematic nature of the illustrated widths again applies. However, in this instance, the rectangular portions (2) do not have square ends, but are provided with pointed ends. Differently shaped ends can affect the switching field and thus be preferred for certain applications. Any suitable end shape can be made use of without departing from the principles of the invention.

On FIG. 3 a yet further alternative is shown, the signature portion comprising a generally square 1 mm by 1 mm array of circular magnetic microdots (3). In this instance material thickness is around 100 nm. Each microdot is 100 μm in diameter. Again this is illustrative only. Alternative shapes can be considered, and again elements of discretely or continuously varying size and/or shape, provided the basic requirement for a device in accordance with the invention that a reproducibly measurable baseline signature response is obtainable is met.

The film is laid down by any suitable method, in particular by optical lithography such as using the method herein described.

FIG. 4 illustrates a mechanical drawing of an example of a small device suitable for measuring the magnetic response of a small area of thin magnetic film, such as a magnetic film comprising a magnetic signature in accordance with the invention, for example the signatures illustrated in FIGS. 1 to 3.

The device to measure the magnetic response comprises a high intensity light source, in this instance an infra-red light emitting diode within the housing (11). The light is collimated by a single pin-hole (12), of diameter in the size range 0.2 mm-5 mm. The light is then reflected off the surface of the magnetic thin film placed in position (15) against it and passes through a second pin-hole (13), with diameter in the size range 0.2 mm-5 mm, and preferably of the same diameter as the first pin-hole.

The reflected light then passes into a light sensitive device within the housing (14), which is by preference a phototransistor or photodiode sensitive to infra-red radiation. In this illustrated embodiment the light sensitive device is selected to have low sensitivity to visible light, allowing the device to be used without optical screening. The device may also be painted black to reduce stray light reflections.

Magnetic field coils (not shown) are attached to the device to apply magnetic fields in the range 0-500 Oe to the magnetic material under test. In the case of the magnetic material under test comprising an array of elongated elements, such as rectangles, by preference the magnetic field coils are oriented so as to apply a field in the plane of the film and either along the long-axis of the elongated structures or at an angle to the long-axis in the range 0°-60°. Additional magnetic field coils can be present to apply an additional field transversely to the long-axis of the wire.

The phototransistor or other light receiving device is connected to suitable electronics (not shown) which record the reflected intensity from the magnetic material while an alternating current is passed through the coils generating the applied magnetic field. Signal processing electronics using a Digital Signal Processor chip or a Microcontroller chip record measured responses over a number of cycles of the applied magnetic field and add them together coherently to reduce noise. The number of cycles recorded will be such that the total acquisition time does not exceed 10 seconds, and for convenience will not exceed 5 seconds. The signal processing electronics then identifies the mean switching field for each of the major switching transitions in the recorded signal. These are then passed to other electronics (not shown) which acquire and if necessary deciphers the prerecorded baseline response from a magnetic strip, smart card, optical bar code, or from a remote textual source or electronic data store or other means, or alternatively transmits the measured response to a remote data comparator having access to the prerecorded baseline response, and a comparison is made.

FIG. 5 illustrates the application of the present invention to a smart chipped card of otherwise generally conventional design. The card (21), typically sized and shaped as a credit card or the like, and which may indeed be used as a credit card or the like, is illustrated in plan view both from above (A) and from below (B). The card carries some alphanumeric information, but its main information storage system is the smart chip (22). This is backed up by optional bar code (23), and magnetic stripe (24) which is typically provided for backward compatibility with magnetic stripe only systems.

A magnetic signature device (26) comprising a 1 mm by 1 mm array of magnetic elements of appropriate design in accordance with the invention is applied on the rear of the smart card. For convenience, in the example shown, it sits within the foot print of the smart chip itself as illustrated by the broken line (28). For many applications it might be convenient to sit the magnetic element (26) within this footprint. An alternative approach to achieve the same effect might be to incorporate the relatively small 1 mm wide magnetic signature device into a specially enlarged space between contacts on the smart chip. However, such placement is purely for convenience, and the magnetic elements (26) could be placed elsewhere on the card.

At the time of manufacture of the card an initial baseline signature reading is taken. One way of doing this is to use a scanning magnetometer. In the illustrated embodiment of a smart card, the baseline response is stored on the card, having first been digitally signed using an asymmetric encryption algorithm such as RSA. The public key can then be made available to a user and/or stored on a reader terminal or even on the card itself without compromising security. The signature can then be used to verify that the card is a genuine product of the manufacturer, and to eliminate the threat of fraudulent misuse of cloned copies of the card, which constitutes an increasing source of both financial transaction fraud and identity fraud.

In use, the card is read by a suitable card reader, in particular by a card reader incorporating a signature device reader such as that illustrated in FIG. 4. The device reader may be incorporated into an existing smart card reader. For example, with the embodiment shown, the reading device for the magnetic element needs to read opposite side of the card from that read by the smart card reader, and so can be incorporated into a conventional smart card reader with relatively little engineering difficulty. In this way, cards and readers remain backwards compatible to conventional card/reader technology not having the identification and authentication system herein described.

The reader measures an actual response from the card. An expected baseline response is also stored upon the card. This can be stored in any readable form, but is conveniently incorporated into the card in one of the existing data storage devices. For example, the baseline signature may be recorded in its encrypted form on the smart chip (22), the bar code (23) or the magnetic strip (24). The reader is thus able to read both the actual magnetic signature and the predetermined and prerecorded expected magnetic signature. The reader is adapted to compare these, within certain tolerance limits, and to indicate whether the card is authenticated or not as a result of that comparison.

The smart card in accordance with various embodiments of the invention will be applicable to all circumstances where conventional smart card technology is being used, including without limitation bank and credit cards, secure information storage cards, identification and authentication cards and the like. It provides a means of authenticating the card as genuine, and thus provides a significant obstacle to fraudulent misuse of counterfeit copies of original cards.

The system represented by the embodiment in FIG. 5 is a simple system, in which a device in accordance with various embodiments of the invention serves merely to authenticate the card as a genuine manufactured product and thus to detect counterfeit copies, and in consequence the predetermined baseline response is conveniently stored upon the card. It will be readily understood that such a system is only an example mode of operation. In one alternative, the original “expected” signature could be stored elsewhere. For example, in relation to the use of a card as illustrated in FIG. 5 as part of a financial services system, for example as a credit card, a system can be envisaged where a plurality of cards are in issuance, where a plurality of readers are in use, and where the readers comprise a distributed network with a central data store such as will already hold customer details being further adapted to process signature information for verification purposes in accordance with the principles herein described. Other modes of operation will also readily suggest themselves.

In FIG. 6 an illustration is provided of the use of an embodiments of the present invention in a lock and key arrangement. A key card (31) of suitable robust material, for example of a suitable plastic material, is provided with a device (36) comprising a 1 mm by 1 mm array of magnetic elements as previously described.

The key card is provided in association with a card reader/lock arrangement illustrated schematically by the remainder of FIG. 6.

The lock (32) incorporates a slot (33) into which the end of the key card (31) can be received. When appropriately positioned therein, the device (36) sits adjacent a reader (34) of the general design illustrated in FIG. 4.

The reader (34) obtains a reading of the magnetic response from the device (36) in the predescribed manner, and passes this response to a control unit (35). The control unit (35) stores or otherwise has access to the predetermined expected response, for example storing this within the lock, optionally in encrypted form It effects the comparison, and in the event that a match is found within predetermined tolerances, passes an instruction to the control means (38) to actuate the lock levers (39) and open the lock.

Although the example illustrated in FIG. 6 is an electromechanical lock, it will of course be understood that the principles of the present invention are equally applicable to all circumstances where a physical or a virtual locking means or other means of access control might be considered. For example, without limitation, a device along the lines of the embodiment illustrated in FIG. 6 could be used in conjunction with an electronic lock for a door or other closure, in conjunction with an electronic ignition for a vehicle, in conjunction with an electronic immobiliser for a vehicle, as a means of controlling access to a piece of electronic equipment, for example by requiring insertion before the equipment operates, as a means of restricting access to a particular service etc.

In the illustrated embodiment, a single card is illustrated in association with the lock. In practice, even for simple single-user locks it is likely to be necessary to provide several keys. It is in the nature of the present invention that these will inherently have different signature devices. Accordingly, the lock would need to store and respond to baseline signatures for each of these devices. More complex modes of operation can also be envisaged where a lock provides for access for a plurality of users, or indeed where a plurality of locks are provided in association with a plurality of users.

In a first example of such operation, a plurality of locks and a plurality of keys are provided in association with a multiple use entry system into a secure area In a second example of such a mode of operation, a plurality of operator cards are provided to control operation of multiple user office equipment. In these examples, all authorised base line signatures may be stored on each lock, or alternatively the locks may be linked together on a distributed network to a central database storing details of the cards of all authorised users. Such a system allows not only good security because of the difficult of producing counterfeit cards, but also allows control and monitoring of access in an active way.

A further embodiment of the invention is illustrated in FIG. 7. In FIG. 7, a signature device in accordance with the invention (46) is incorporated on a label attachable to an item to be identified/protected. The label comprises a plastic tab (41) which optionally incorporates alphanumeric information; a bar code (44) etc. to store, for example identification information, information of origin, pricing information or the like about item to be labelled. The tab (41) is attached to an item to be labelled by the attachment strap (42). In the embodiment illustrated, the attachment strap (42) is intended as a simple loop attachment. Attachment may be releasable or permanent. Where security and permanence of attachment of the label are of particular importance a more complex attachment would be readily envisaged which might for example include locking mechanisms, tamper prevention mechanisms, tamper indication mechanisms and the like.

The embodiment of FIG. 7 allows labelling of items in either a temporary or permanent manner where it is not practical or desirable to incorporate a device in accordance with the invention directly onto the item itself. Example modes of use include without limitation improved security airline luggage labels, authenticity labels for high value branded items, in particular clothing and the like; origin and identity labels for the same, for stock control purposes, and for example for identifying original and hence controlling unauthorised importation of genuine branded articles intended for another market; marking of items for stock control purposes; price marking of items, labels being used in such a way as to make it difficult for a purchaser to transfer a (lower) price label from another item to obtain goods at a fraudulently low price.

The normal mode of operation of a label of the type illustrated in FIG. 7 will be authentication. Accordingly, the prerecorded signature information will usually be stored on the tab (41). The prerecorded information will be stored in any suitable machine readable form. In the example given it could be incorporated in the bar code. A reader will be provided adapted to read both the magnetic signature of the device (46) and the encrypted expected signature, and to effect a comparison to authenticate the label. The security effectiveness of the label lies in that it is very difficult to copy, since the random nature of the signature means that a copied label will be immediately identifiable as such.

FIG. 8 illustrates a data storage disk such as a CD, DVD or the like to which a device in accordance with the invention has been applied. The disc (51) incorporates a magnetic signature tab (56) comprising magnetic elements as above described preferably within the dead area (53) not otherwise carrying data. An encrypted predetermined reading of the signature (56) is provided elsewhere on the disc.

At its simplest, in a first mode of operation, the system allows the manufacture to authenticate original CDs/DVDs, to identify counterfeit copies, and in association with a suitable stock control system to track origin and destination of genuine originals, and to identify unauthorised importation and the like.

In a more advanced mode of operation, disc readers can be manufactured which incorporate device readers to read the device (56) and to authenticate the disc, and which will be disabled from playing unauthorised copies. It is also possible to envisage a system whereby such modified players can be used in conjunction with the identification/authentication system of the invention as part of an end user licence arrangement.

FIG. 9 is an example of the use of the invention on a formal identification document Such a document might be an identification or authorisation document, such as a passport, driver's licence, authorisation or qualification certificate or the like, an identity or authorisation certification intended to accompany, verify or otherwise identify an article, or any other document where counterfeit copies might be a problem.

The document (61) in the example includes visual information (62), for example a photograph, written information (63), and a bar code (64). It might include other data storage or security devices.

A device comprising magnetic elements as above (66) is incorporated into the document. This device is readable in the manner above described. In one mode of operation, the device (66) serves a simple authentication purpose, and an encrypted prerecorded reading of its expected magnetic response is also incorporated into the document. Conveniently in the example given this could be incorporated into the bar code, or otherwise stored in a readable form. However, it will be appreciated systems in more sophisticated systems it would be possible to store the expected magnetic signature remotely, optionally with further identification and/or other security details.

The device in accordance with the invention applied to documentation in this way serves primarily as a form of copy protection. It therefore serves as a cheap and convenient authentication device in all circumstances where there is a vulnerability to fraud arising from the counterfeiting of genuine originals, for example in relation to identification documents, formal certificates, financial paperwork such as cheques, paper money and the like, important legal documents, and other such documentation.

Various embodiments of a security device incorporating magnetic elements can be provided. One process of manufacturing various of such security devices on a silicon substrate using optical lithography will now be described, by way of example.

The manufacturing process is illustrated in FIGS. 10a to 10h. The process starts in FIG. 10a with a cleaned and polished silicon wafer 704. In various embodiments, the silicon substrate is approximately 0.5 mm thick in order to facilitate handling and provide a rugged security device. A photoresist layer 714 is spun onto the wafer to provide a smooth coating as shown in FIG. 9b. The wafer and photoresist layer 714 are then baked to set the photoresist layer 714.

FIG. 10c illustrates the device of FIG. 10b post-exposure to UV radiation or near-UV radiation (e.g. at 405 nm). The regions 708 represent exposed regions. The exposed regions 708 are directly written onto the upper surface 701 of the photoresist layer 714 using a commercially available direct write scanning optical lithography system such as, for example, a NanoMOKE2 system with a LaserWriter add-on supplied by Durham Magneto Optics Ltd. In this way, an individual one-dimensional or two-dimensional pattern can be written into the photoresist layer 714 for each security device that is manufactured. This pattern may define a plurality of wire shapes, such as, for example, those illustrated in FIG. 1.

FIG. 10d shows the device of FIG. 10c after is has been developed to remove exposed photoresist 708. Removal of the exposed photoresist 708 exposes portions 710 of the underlying silicon substrate 704.

Subsequently, as shown in FIG. 10e, magnetic elements 702 formed of a permalloy material such as, for example, Ni₈₀Fe₂₀ (see, for example, Bozorth, Ferromagnetism, ISBN 0-7803-1032-2, for further information) are deposited in exposed portions 710 by a sputter deposition or evaporation process, typically to a thickness in the range from about 10 to about 100 nm, e.g. to about 40 nm. Further layers 712 of permalloy material also form on the remaining unexposed photoresist 706 during the sputter deposition process.

Next, metal capping layers 716, 718 of gold or aluminium are formed over the permalloy layers 712 and magnetic elements 702, as illustrated in FIG. 10f. The capping layer 718 is designed to protect the permalloy layer from oxidation and also provides an enhanced optical reflectivity.

The unexposed photoresist 706 along with overlying permalloy layers 712 and capping layers 716 are removed using a suitable solvent, e.g. acetone, to leave the structure illustrated in FIG. 10g. The resulting structure comprises the magnetic elements 702 formed on the silicon substrate 704 separated by exposed silicon substrate regions 720. The upper surfaces of the magnetic elements 702 are capped by capping layers 718.

The aforementioned resulting structure is placed into a plasma enhanced chemical vapour deposition (PECVD) chamber where a silicon dioxide (SiO₂) layer 722 is deposited upon the upper exposed silicon substrate regions 720 and capping layers 718. The silicon dioxide layer 722 forms an optically transparent layer (including, inter-alia, a layer that is substantially transparent to infra-red electromagnetic radiation). The resulting security device 700 is shown in FIG. 10h.

Where several security devices 700 are manufactured upon a single silicon substrate 704, the silicon substrate 704 can subsequently be diced into a plurality of individual security devices 700.

The applicants have produced several prototype security devices using the process hereinbefore described. During production of these prototype security devices the sputter deposition process parameters used were as follows: 250 W power setting; base pressure 5×10⁻⁷ mbar, Argon gas; gas pressure 1 to 2 mTorr, flow of 5 cc/minute; substrate rotation rate 10 rpm; deposition rate 1 to 1.5 Angstroms per second; and a substrate temperate of 22 to 27° C. It is also possible to apply a magnetic field along the plane of the device during the manufacturing process.

The applicants note from an analysis of their prototype security devices, that fine tuning of the growth rate and/or sputter pressure for the magnetic elements can provide improvements to sharp switching mode magnetic switching characteristics. The applicants have also noted from an analysis of their prototype security devices, that magnetically soft materials tend to give rise to desirable magnetic switching properties.

Once a security device had been manufactured it is tested, either alone or as part of a batch of such security devices, to determine its characteristic response. The characteristic response is measured to ensure it provides for adequate identification of the particular security device.

Where embodiments of the invention use the magnetic switching properties of the material to produce a signature, baseline or characteristic response, magnetically soft materials are useful. Magnetically soft materials are ferromagnetic materials in which the magnetism can be easily reversed. These materials generally have narrow square-shaped hysteresis loops. Thus, the magnetisation of a magnetic element made from such a material switches its direction in response to an applied field relatively sharply. The coercivity of such materials (i.e. the reverse field needed to drive the magnetisation of a magnetic element made of such a material to zero after being saturated) tends to be relatively low, thereby ensuring that relatively low-field-strength magnets can be used to cause a switch in the magnetisation direction of the magnetic element. Such, relatively low field-strength magnets may be fairly inexpensive, generally compact and easily driven to produce a controlled magnetic field of good uniformity.

A measurement of jitter may be used to provide a parameter relating to a signature, baseline or characteristic response. A jitter measurement may be made by repeating measurements on the magnetic elements and determining how much the coercivity varies between sets of measurements. These sets of measurements can be repeated many times for the magnetic elements of the security device. In one example, coercivity may be measured one hundred times for the magnetic elements at room temperature. The measured coercivity values are then fitted to a Gaussian bell-curve, and the mean coercivity and jitter (as indicated by the mean and standard deviation Δ of the fitted Gaussian curve, respectively) calculated.

Magnetic elements may be tested to determine whether or not they operate in a repeatable manner. A Kerr magnetometer, as described in Applied Physics Letters, Vol. 73, p. 3947, 1998, is used to measure the coercivity of the magnetic elements.

The applicants have found that for various embodiments, over a typical likely operating temperature (for example, from −20° C. to 50° C. where anti-misting measures are provided in a reader), jitter exhibited only a weak temperature dependency.

In various embodiments, there is a measurable dependence of mean coercivity on temperature. However, provided that the mean coercivity of a plurality of magnetic elements varies in the same way with temperature, the coercivity differences between magnetic elements remains almost constant. Thus, when comparing the measured mean coercivity against the premeasured characteristic response, an allowance may be made for a constant offset between the two sets to compensate for different temperatures.

However, if desired or required for various other embodiments, coercivity and/or jitter measurements may be made at several temperatures, including temperatures outside a normal operating temperature range. For example, sets of measurements could be made on each magnetic element at −50° C., 0° C. and 65° C. for a security device rated for operation from about −20° C. to about 50° C.

In various embodiments, security devices may have their baseline or premeasured characteristic response defined by a mean coercivity value and/or a jitter value Δ determined as indicated above. Various other embodiments use, for example, either a mean coercivity value or a jitter value to represent a baseline or premeasured characteristic response. In use, the baseline or premeasured characteristic response of a security device is compared to its measured characteristic response to determine if that security device is a forgery.

The baseline or premeasured characteristic response can be encoded, for example, by digitising the values of the mean coercivity and/or the jitter value Δ. In various embodiments, these values are stored in encrypted form upon the corresponding security device, either with or without an identifier that may be unique. In various other embodiments, these values are stored separately from the corresponding security device. In various embodiments, during a reading operation (as described herein) the digitised values of mean coercivity and/or jitter value Δ representing a baseline or premeasured characteristic response can be retrieved/recovered for a particular security device and compared to measured values of mean coercivity and/or jitter value Δ for a security device purporting to be the same device, so as to determine whether or not the security device whose signature or characteristic response has been measured is a forgery.

Security devices may be attached to articles in order to aid in identifying such articles as genuine or non-counterfeit. In use it is necessary to read the signature or characteristic response of a particular security device in order that it may be compared to a baseline or premeasured characteristic response. Any differences between the measured and premeasured response, outside of any allowable limits, indicate that the security device that has been read is a forgery. Since the production of magnetic nucleation centres is beyond the control of the manufacturer, any copying of the device will almost invariably result in a different characteristic response, such as, for example, mean coercivity and jitter values.

Various embodiments of systems for reading security devices, both hand-held or otherwise are envisaged. Various such embodiments are described herein in connection with FIGS. 11 to 16 of the drawings.

FIG. 11 shows a reading arrangement 930 forming a component of a security device reading system for obtaining a measured characteristic response of a security device 900 while the security device 900 is subject to an applied magnetic field 932. The reading arrangement 930 can detect changes in the polarisation and/or intensity of light reflected from the magnetic elements using the magneto-optic Kerr effect (MOKE).

The reading arrangement 930 comprises an aluminium block 934 whose internal and external surfaces are blackened using a black matt anti-reflection paint. The size of the an aluminium block 934 is typically 2 cm×2 cm×1 cm. The aluminium block 934 comprises beam path channels 938, 940, 942. A near infra-red or visible laser diode 936, which is provided with collimating optics (not shown), is operable to produce a collimated laser beam 944 at a wavelength of, for example, 600 to 1550 nm. One embodiment uses a laser diode operating at 670 nm. The laser beam 944 passes though a first beam path channel 938, before it leaves the aluminium block 934 and is incident upon a mirror 950.

The laser beam 944 is reflected from the mirror 950 into a second beam path channel 940 formed in the aluminium block 934. A polariser 952 placed into the second beam path channel 940 converts the laser beam 944 into a plane polarised laser beam 947. The plane polarised laser beam 947 then leaves the second beam path channel 940.

The aluminium block 934 also comprises a third beam path channel 942. The third beam path channel 942 is oriented so as to collect reflected light 949 that is reflected from a security device 900 when being read. Typically, if a security device 900 has wire-shaped or flattened wire-shaped magnetic elements 902, the applied field 932 is applied in a direction substantially parallel to the axis of the magnetic elements 902.

An analyser 954, used in various embodiments, incorporating an optional quarter wave plate and polariser is placed into the third beam path channel 942. The analyser 954 passes light of a first polarity and blocks light of a second an orthogonal polarity. Light of the first polarity is reflected from magnetic elements 902 and gives rise to an aggregate signal that measures the mean polarisation/reflectivity state (sometimes known as the aggregate response) of the magnetic elements illuminated by the beam 947.

The polariser 952 and the analyser 954 are arranged to measure the longitudinal magneto-optic Kerr effect signal produced when the plane polarised laser beam 947 is incident upon the magnetic elements 902. Other magneto-optic Kerr effect arrangements, for example, including arrangements without a polariser and/or analyser and/or using a transverse or polar arrangement may also be used. However, a benefit of using a longitudinal magneto-optic Kerr arrangement is that it generally provides an improved signal as compared to transverse or polar arrangements.

Aligned with the third beam path channel 942 is a detector unit 956, which in this embodiment incorporates a focussing lens and a photodiode circuit or phototransistor circuit sensitive to illuminating radiation. The photodiode circuit is responsive to light transmitted through the analyser 954 to provide a signal proportional to the magnetisation of any magnetic elements 902 illuminated by the plane polarised laser beam 947.

FIG. 12 shows a field generation system 935, a detection system 937, and a control and processing system 939 forming, in conjunction with the reading arrangement 930 described above, a further part of one embodiment of a security device reading system.

The field generation system 935 comprises components for producing a time varying applied magnetic field 932 for applying to a security device 900. The field generation system 935 comprises a driver circuit 966 operable to drive field generation coils 933a, 933b in response to a coil driving signal 970. The coil driving signal 970 is a periodic sinusoidal signal composed of a plurality of individual sinusoidal waveforms 972 oscillating at a frequency of 100 Hz (see FIGS. 13 and 15), that drives the drive field generation coils 933a, 933b to produce a sinusoidinally oscillating magnetic field oscillating at 100 Hz. In this embodiment, the 100 Hz sinusoidal waveform is produced by a conventional electronic oscillator circuit (not shown).

The field generation system 935 additionally comprises a cross-over detector 968 for detecting polarity changes in the coil driving signal 970. The cross-over detector 968 produces a synchronisation signal 981 in response to being driven by the driver circuit 966, as shown in FIG. 14. The synchronisation signal 981 is composed of a sequence of spikes 983 each produced at a time when the polarity of the coil driving signal 970 changes. In various other embodiments, the same microcontroller that logs the Kerr signal is used to generate the applied field sequence (via a Digital to Analogue Converter), so the microcontroller can control synchronisation therebetween.

The detection system 937 comprises detector unit 956 for producing a signal in response to incident light 948. The detector unit 956 is coupled to an amplifier 958. Signals produced by the detector unit 956 are amplified by the amplifier 958 to provide a unipolar detector signal 973 (see FIG. 16). The unipolar detector signal 973 is then fed into an analogue to digital converter (ADC) 960 for digitisation. The ADC 960 is a 10 bit device operating at a 10 kHz sampling frequency, thereby giving 1024 possible discrete data levels for each of the 100 samples taken over the time taken for one cycle of a 100 Hz cycle to complete.

In one embodiment, the ADC 960 operates at 10 kHz and acquires around 100 data points per applied magnetic field cycle. The applied field is applied at a frequency of around 10 kHz/100=100 Hz. Data is averaged for around 0.5 sec, i.e. there are 50 data sets averaged for a single magnetic element From this mean coercivity and jitter are measured. The process is then repeated for another magnetic element. In total around 8 magnetic elements are analysed in this way.

The control and processing system 939 is used to acquire measured data representative of the signature/characteristic response of the security device 900 from the detection system 937, analyse that measured data and compare it with a premeasured characteristic response to determine if the security device 900 is genuine.

The control and processing system 939 comprises a processing unit 962 having an associated data store 974. In various embodiments, the processing unit 962 comprises a microprocessor or microcontroller and associated memory (not shown), including a ring buffer to which data samples from the ADC 960 are constantly fed when the ring buffer is enabled by the microprocessor.

When the security device reading system is started, the ring buffer is disabled by the microprocessor. In order to begin accumulating data into the ring buffer, a first spike 983 is received by the microprocessor. This triggers the microprocessor to begin a count of the number of synchronisation spikes 983 that are received and simultaneously to enable the ring buffer. Thus, data begins accumulating into the ring buffer in synchronisation with a polarity transition occurring in the applied magnetic field 932. When the microprocessor detects the Nth spike 983 (e.g. the 100th), a signal is sent to inhibit further accumulation of data into the ring buffer. The ring buffer at this time will contain N sets of data each accumulated during one half cycle of the applied magnetic field 972, with each set of data representing a digitised respective portion 975, 977 of the unipolar detector signal 973 at a respective time during the time duration t (t=N×applied magnetic field frequency/2) of the data accumulation. (e.g. t=0.5 second duration for 100 cycles at 100 Hz with N=100, and 5,000 individual measurements are made with an ADC rate set to 10 kHz).

As indicated above, data sets can be accumulated in a variety of manners. Once acquired, the data can be processed to extract a variety of information regarding the measured signature or characteristic signal response. Standard algorithms can be applied to the data sets to calculate the mean measured coercivity and/or jitter as given by a measure of the standard deviation of coercivity measurements. Examples of such algorithms may be found, for example, in “Numerical Recipes in C: The Art of Scientific Computing,” W. H. Press, S. A. Teukolsky, W. T. Vetterling and B. P. Flannery, (Cambridge University Press, Cambridge, 1993).

Data fitting can either be done by the same microprocessor/microcontroller that determines the measured characteristic signal response, or by a connected computer system. For example, where a remote data base stores the premeasured characteristic response, raw measured characteristic signal response data can be transmitted to a remote processor to perform a Gaussian fitting. Similarly, where used as part of a fraud detection system, a reader may be connected to a Palm-top computer which stores premeasured characteristic response data by downloading it from the internet, and compares it to the measured characteristic signal response. In various embodiments, Palm-top computers can be used as the interactive display of the reader and also as a means of accessing remote data bases, e.g. by using GSM telephones.

Various ways exist for determining the baseline or premeasured characteristic response of a security device. These ways vary according to the type of security device and depend, for example, on whether or not the premeasured characteristic response is stored/encoded on the security device; whether or not the baseline/premeasured characteristic response is encrypted; and whether or not a unique identifier is provided in association with the security device. All these possibilities provide feasible embodiments.

In various other embodiments, a smart card carries a security device and unique identifier and encrypted baseline or premeasured characteristic response information are stored in the smart card. The smart card is read in a conventional manner and a measured signature or characteristic response is measured as herein described.

In an embodiment of a security device reading system, premeasured characteristic response information is stored in a database to which one or more processing units have access. The baseline or premeasured characteristic response information is preferably encrypted. Such a system may be distributed and comprise a remote server coupled through a network to one or more security device readers. A system according to this embodiment is operable to determine a unique identifier for each security device and to retrieve baseline or premeasured characteristic response information corresponding to the unique identifier determined by the security device reading system. The baseline or premeasured characteristic response information can then be decrypted as necessary by a respective security device reader.

In embodiments of the security device reading system, once the information regarding the measured signature or characteristic signal response has been extracted it is compared by the microprocessor to the baseline or premeasured characteristic response, possibly decrypted using a private asymmetric data key, to determine whether or not the security device can be classed as non-counterfeit Such a comparison is made within a margin of error allowed for variations that are introduced, for example, by temperature fluctuations.

While certain of the example materials described herein are ferromagnetic, those skilled in the art will realise that other types of magnetic and/or non-magnetic elements may be used provided they give rise to a suitable measurable characteristic response. For example, non-magnetic elements may be used where such elements produce a measurable response in an applied magnetic field, where that response can be measured to provide a signature or characteristic response.

Those of ordinary skill in the art will be aware of various techniques that can be used to manufacture and characterise magnetic elements suitable for security devices. An example of one such manufacturing technique and one such characterisation process can be found in “Optimised process for the fabrication of mesoscopic magnetic structures,” Adeyeye et al, Journal of Applied Physics, Vol. 82, No. 1, pp. 469-473, 1 Jul. 1997, which investigated the effect of magnetic element size upon the magnetic properties thereof.

Embodiments produced in accordance with the invention may incorporate reflectivity/contrast enhancement measures either alone, or in any combination. Materials such as gold, aluminium, chromium and/or tantalum can be laid beneath and/or above magnetic elements to enhance their reflectivity and/or the Kerr signal that the magnetic elements provide. Areas of a security device may be treated to reduce their reflectivity in order to improve the reflectivity/contrast between the magnetic elements and their surrounding areas.

In various embodiments, magnetic elements in the shape of wires or flattened wires are provided. The end shape of such wires can be controlled during manufacture of a security device. An angled end, for example, from about 60° to about 90° may be provided In various other embodiments flattened ends and/or semi-circular ends may be provided to influence magnetic nucleation. The shape of the ends may be chosen to provide improved magnetic switching characteristics.

Although the invention has been described in relation to particular embodiments, it will be appreciated that the invention is not limited thereto, and that many variations are possible falling within the scope of the invention.

It will be appreciated that certain of various embodiments of the invention described above are implementable and/or configurable, at least in part, using a data processing apparatus, such as, for example, hardware, firmware and/or a computer configured with a computer program. The computer program can be stored on a carrier medium in data processing apparatus usable form. The carrier medium may be, for example, solid-state memory, optical or magneto-optical memory such as a readable and/or writable disk for example a compact disk and a digital versatile disk, or magnetic memory such as disc or tape, and the data processing apparatus can utilise the program to configure it for operation. The computer program may be supplied from a remote source embodied in a carrier medium such as an electronic signal, including radio frequency carrier wave or optical carrier wave.

The foregoing examples are merely illustrative of the possible uses of a device in accordance with various aspects of the invention. It will be appreciated that a signature device in accordance with various embodiments of the invention could have a huge range of applications, in particular being applicable to any situation where significant commercial or security issues arise from the misuse of counterfeit copies of original items.

Those of ordinary skill in the art will be aware that the description herein relates merely to illustrative examples of how the invention may be put into effect, and that many embodiments incorporating one or more components, e.g. of other embodiments, can be envisaged, along with further embodiments not explicitly described herein. For example, data acquisition rates, sample

1-75. (canceled)

76. A security device comprising two or more magnetic elements, wherein said magnetic elements are responsive to switch magnetisation state in response to an applied magnetic field to provide a characteristic response, wherein the elements are made of magnetically soft material that discretely switches magnetisation state at an applied field strength that depends upon inherent structural variations that are present in the magnetically soft material.

77. The security device of claim 76, wherein the security device stores a premeasured characteristic response.

78. The security device of claim 76, wherein said characteristic response represents an aggregate response of said magnetic elements to said applied magnetic field.

79. The security device of claim 76, wherein said magnetic elements are supported by a substrate.

80. The security device of claim 79, wherein said magnetic elements are supported on said substrate.

81. The security device of claim 76, wherein the magnetic elements comprise thin layer magnetic material.

82. The security device of claim 81, wherein the thin layers of magnetic material are less than 1 μm thick.

83. The security device of claim 82, wherein the thin layers of magnetic material between 10 nm and 100 nm thick.

84. The security device of claim 76, wherein said magnetic elements are responsive to said applied magnetic field to switch the magnetisation or magnetic polarisation of at least one of the magnetic elements.

85. The security device claim 76, wherein at least one of the magnetic elements comprises a magnetically soft material selected from one or more of: nickel, iron, cobalt and alloys thereof with each other or silicon, such as nickel iron alloy, cobalt iron alloy, iron silicon alloy or cobalt silicon alloy.

86. The security device of claim 85, wherein said magnetically soft material is a permalloy material.

87. The security device of claim 76, wherein at least one of the magnetic elements is substantially wire-shaped or flattened wire shaped.

88. The security device of claim 76, wherein the device comprises a generally parallel array of elongate rectangular magnetic elements.

89. The security device of claim 88, wherein the magnetic elements comprise an array of generally parallel magnetic nanowires.

90. The security device of claim 76, wherein the magnetic elements have generally the same size and/or shape.

91. The security device of claim 76, wherein several discrete groups of differently sized and/or shaped magnetic elements, the magnetic elements being generally similarly sized and/or shaped within each group, are provided so that several different switching fields can be identified.

92. The security device of claim 91, comprising an ensemble of rectangular magnetic elements in parallel array including several discrete groups of magnetic elements of different widths.

93. The security device of claim 76, wherein differently sized and/or shaped magnetic elements are provided in a continuously varying array, so that variations in sized and/or shape between a magnetic element and its neighbours are minimised to avoid large discontinuities.

94. The security device of claim 93, comprising an ensemble of rectangular magnetic elements in parallel array of width varying continuously across the array.

95. The security device of claim 76, further comprising a single relatively large area magnetic element for use as a reference element.

96. The security device of claim 76, wherein at least one of the magnetic elements is backed by a light reflective layer.

97. The security device of claim 76, wherein at least one of the magnetic elements is provided proximal a reduced light reflectivity portion of said security device.

98. The security device of claim 76, wherein the magnetic elements are arranged to provide a linear pattern.

99. The security device of claim 76, wherein said magnetic elements are arranged to provide a two-dimensional pattern.

100. The security device of claim 76, further comprising a unique identifier incorporated therewith.

101. The security device of claim 100, wherein said unique identifier is provided by way of one or more of: an optically readable bar code; one or more optical indicia; a magnetically encoded identifier; and an electronic identifier.

102. The security device of claim 101, mounted upon a smart-card, wherein said electronic identifier is provided by a smart-card chip provided on said smart-card.

103. The security device of claim 76, wherein premeasured characteristic response information representing one or more measurable parameters of said characteristic response is stored on said security device.

104. The security device of claim 103, wherein said premeasured characteristic response information is in encrypted form.

105. The security device of claim 104, wherein said premeasured characteristic response information is encrypted using an asymmetric encryption algorithm with the private key used for enciphering being kept secret and the public key used for deciphering being made available to any reader of the security device.

106. The security device of claim 77, wherein the premeasured characteristic response is stored in machine-readable form.

107. A method of manufacturing a security device, comprising:
providing two or more magnetic elements made of magnetically soft material having random variations introduced into the magnetically soft material during fabrication, wherein said magnetic elements discretely switch magnetisation state in response to an applied magnetic field in order to generate a characteristic response.

108. The method of claim 107, comprising providing said magnetic elements on a substrate.

109. The method of claim 107, comprising forming at least one of the magnetic elements using a lift off or wet etching process.

110. The method of claim 107, comprising forming at least one of the magnetic elements using an ion beam etching process.

111. The method of claim 107, comprising measuring the magnitude(s) of one or more magnetic parameters of said magnetic elements.

112. The method of claim 111, comprising measuring one or more of coercivity and jitter values.

113. The method of claim 111, comprising using the measured magnitude(s) of said one or more magnetic parameters to represent premeasured characteristic response information.

114. The method of claim 113, comprising encrypting said premeasured characteristic response information.

115. The method of claim 113, comprising storing said premeasured characteristic response information in encrypted or unencrypted form on said security device.

116. The method of claim 113, comprising storing said premeasured characteristic response information in encrypted or unencrypted form in a storage medium remote from said security device.

117. The method of claim 116, comprising storing said premeasured characteristic response information in encrypted or unencrypted form in a database.

118. The method of claim 107, further comprising providing said security device with a unique identifier.

119. The method of claim 98 comprising: using the measured magnitude(s) of said one or more magnetic parameters to represent premeasured characteristic response information, and storing a representation of said unique identifier in association with said premeasured characteristic response information.

120. A system for reading a security device, comprising:
a magnetic field generation system for applying a magnetic field to a security device comprising two or more magnetic elements, wherein said magnetic elements are responsive to switch magnetisation state in response to an applied magnetic field to provide a characteristic response, wherein the elements are made of magnetically soft material that discretely switches magnetisation state at an applied field strength that depends upon inherent structural variations that are present in the magnetically soft material;
a detection system for measuring one or more discrete magnetisation switching parameters representative of a measured characteristic response of said security device generated in response to said magnetic field,
wherein said system is operable to compare said one or more discrete magnetisation switching parameters representative of a measured characteristic response to one or more respective parameters of a premeasured characteristic response to determine whether respective measured and premeasured parameters are substantially equivalent.

121. The system of claim 120, wherein said measured characteristic response and said premeasured characteristic response are representative of an aggregate response produced by said two or more magnetic elements.

122. The system of claim 120, wherein the magnetic field generation system is operable to apply a time varying magnetic field to a security device.

123. The system of claim 120, wherein a light beam is used to interrogate said security device.

124. The system of claim 123, wherein said light beam is a visible or near-infrared beam produced by a laser diode.

125. The system of claim 120, wherein said parameters represent one or more of coercivity and jitter values.

126. The system of claim 123, wherein said detection system incorporates magneto-optic Kerr effect detection apparatus for detecting changes induced in said light beam by magnetic elements of said security device.

127. The system of claim 126, wherein said magneto-optic Kerr effect detection apparatus is configured to operate in transverse mode.

128. The system of claim 120, further operable to deflect said light beam across the surface of said security device.

129. The system of claim 120, further operable to read a unique identifier from said security device.

130. The system of claim 129, wherein said unique identifier is identified by reading one or more of: an optically readable bar code; one or more optical indicia; a magnetically encoded identifier; and an electronic identifier.

131. The system of claim 120, further operable to determine said one or more respective parameters of the premeasured characteristic response by reading said one or more parameters from said security device.

132. The system of claim 120, further operable to determine said one or more respective parameters of the premeasured characteristic response by reading said one or more parameters from a database.

133. The system of claim 132, wherein said database is remotely located from said detection system.

134. The system of claim 120, further operable to decrypt premeasured characteristic response information where it is read or provided in encrypted form.

135. A method for reading a security device comprising two or more magnetic elements, wherein said magnetic elements are responsive to switch magnetisation state in response to an applied magnetic field to provide a characteristic response, wherein the elements are made of magnetically soft material that discretely switches magnetisation state at an applied field strength that depends upon inherent structural variations that are present in the magnetically soft material, the method comprising:
applying a magnetic field to a security device comprising two or more magnetic elements made of magnetically soft material;
measuring one or more discrete magnetisation switching parameters representative of a measured characteristic response of said security device generated in response to said magnetic field; and
comparing said one or more discrete magnetisation switching parameters representative of a measured characteristic response to one or more respective parameter(s) of a premeasured characteristic response to determine whether respective measured and premeasured parameters are substantially equivalent.

136. The system of claim 135, wherein said measured characteristic response and said premeasured characteristic response are representative of an aggregate response produced by said two or more magnetic elements.

137. The method of claim 135, comprising applying a time varying magnetic field to a security device.

138. The method of claim 135, wherein measuring of one or more parameters representative of a measured characteristic response of said security device generated in response to said magnetic field comprises measuring one or more of coercivity and jitter values.

139. The method of claim 135, comprising interrogating said security device using a light beam.

140. The method of claim 135, comprising operating a laser to produce a visible or near-infrared beam.

141. The method of claim 139, comprising detecting changes induced in said light beam by magnetic elements of said security device using the magneto-optic Kerr effect.

142. The method of claim 141, comprising using the magneto-optic Kerr effect transverse mode.

143. The method of claim 135, comprising reading a unique identifier from said security device.

144. The method of claim 143, comprising identifying said unique identifier by reading one or more of: an optically readable bar code; one or more optical indicia; a magnetically encoded identifier; and an electronic identifier.

145. The method of claim 135, comprising determining said respective one or more parameters of the premeasured characteristic response by reading said one or more parameters from said security device.

146. The method of claim 135, comprising determining said one or more respective parameters of the premeasured characteristic response by reading said one or more parameters from a database.

147. The method of claim 146, comprising accessing a database remotely located from said detection system.

148. The method of claim 135, further comprising decrypting premeasured characteristic response information where it is read or provided in encrypted form.

149. A product comprising a security device comprising two or more magnetic elements, wherein said magnetic elements are responsive to switch magnetisation state in response to an applied magnetic field to provide a characteristic response, wherein the elements are made of magnetically soft material that discretely switches magnetisation state at an applied field strength that depends upon inherent structural variations that are present in the magnetically soft material.

150. The product of claim 149, comprising one or more of: a document; a passport; an identity card; a compact disc; a digital versatile disc; a software product; packaging; an item of clothing; an item of footwear; a smart-card; a credit or bank card; a cosmetic item; an engineering part; an accessory; and any other goods and/or items of commerce, whether manufactured or otherwise.
